(19) United States
(12) Patent Application Publication
(10) Pub. No.: US 2005/0078006 A1
(43) Pub. Date: Apr. 14, 2005

(54) Facilities management system

(76) Inventors: J. Marc Hutchins, Ontario (CA); Nicholas D Hutchins, Ontario (CA)

Correspondence Address: Charles C Valauskas;Baniak Pine & Gannon, Suite 1200, 150 North Wacker Drive, Chicago, IL, 60606-1606, US

(21) Appl. No.: 10/495,480

(22) PCT Filed: Nov. 20, 2002
(86) PCT No.: PCT/CA02/01769

Related U.S. Application Data
(60) Provisional application No. 60/348,048, filed on Nov. 20, 2001.

(51) Int. Cl. G08B 13/26

(52) U.S. Cl. 340/561

(57) ABSTRACT

A system is described for management of an operations area. The management system includes a central processing component with one or more central processors. An active monitoring system component is connected to the central processor. The active monitoring system includes tags and readers for individual identification of one or more tagged entities. The active monitoring system component is arrayed to create a management zone. The tags and readers are linked to the central processing component such that information from the tags and readers is received and analyzed by the central processing component. A passive monitoring system component is connected to the central processor. The passive monitoring system identifies non-tagged entities entering the management zone and additional information is communicated to the central processing component for analysis.

This application claims benefit of U.S. Provisional Application No. 60/348048, filed November 20, 2001.

### TECHNICAL FIELD

The present invention is directed to a system for management of an operations area. Generally, the system includes a central processing component and a monitoring system that includes an active monitoring system component including electronic tags and read/write sensors for identification of tagged assets, and a passive monitoring system component for identification of non-tagged entities. The system may be used to monitor large areas or facilities, such as airports, and sub-areas nested or associated with the large areas. The system may also be utilized in areas of ingress and/or egress such as gates, portals or doors, or in urban areas around secure facilities, office buildings, factories, or any other areas where control of resources or assets is important.

### BACKGROUND OF THE INVENTION

Areas—such as campuses or ranges—, facilities—such as such as airports—, and buildings often may include areas of operation to which access by the public in general, personnel, and/or certain types of equipment is limited or altogether prohibited. Within these operation areas, other areas may be set aside to which even a more specific group of employees, personnel, and equipment, such as vehicles may be permitted access. For purposes of this application, the term “operations area” shall mean any portion of an area, range, campus, facility, or building to which access is monitored, controlled, limited or altogether prohibited or across whose boundary certain personnel, assets, and materials are controlled, monitored or not permitted from a non-operations area—termed a “perimeter area” where access and activity is not controlled or monitored. While the invention of the present application will be described in terms of its utility in airport applications, the invention may be used in other contexts such as to manage operation areas of defense installations, military compounds, and corporate or institutional campuses or other areas that need access differentiation and control.

While apparatus are known for identifying, authenticating, monitoring, tracking, controlling, and managing individuals, vehicles, and materials moving through limited areas of egress and ingress—such as paths, gates, doors, and other exits and entryways—termed “portals” for purposes of this application, achieving the same level of control for vast open and irregularly shaped operations areas—such as, but not limited to airport tarmacs and airport movement areas—is much more difficult. Physical barriers such as. fences, walls, and locking doors and gates are conventionally used to limit access beyond the perimeters. However, such physical barriers may be defeated and unauthorized access gained. Physical barriers also tend to impede movement in such areas. To monitor whether someone is seeking to and/or may have gained unauthorized access to an operations area, surveillance through cameras is widely used. However, such surveillance requirements may not be practicable for large areas and may require one or more individuals to continuously observe the screens on which the images from the surveillance cameras are transmitted. This is a time consuming and labor intensive task requiring constant vigilance. However, if the task is not performed, unauthorized access may be achieved and undocumented.

A demand therefore exists by which large, and possibly irregularly shaped areas—such as airport areas, defense installations, military compounds, and corporate or institutional campuses (termed “operations area” for purposes of this application)—may be better managed, largely without impeding the movement of traffic, personnel or the pursuit of regular business. The present invention satisfies the demand.

### SUMMARY OF THE INVENTION

The present invention is a system and related methods and software by which operations areas or portions thereof to be monitored may be defined and identified and personnel, vehicles, luggage, objects, documents and any other individuals or materials or equipment within the operations area may be monitored in order to better manage these defined areas. More specifically, the management system of the present invention includes a monitoring system that includes an active monitoring system component and a passive monitoring system component all able to communicate—such as through a variety of means including wired and wireless communication systems that may provide information that is a scrambled and/or encoded—to and from a central processing component that may include one or more central processors.

The active monitoring system component of the present invention includes the use of tags to identify all individuals, equipment, materials, and vehicles, a plurality of readers and other sensors (the readers and other sensors termed also “readers” for purposes of this application), organized in a pattern to create a management zone or operations area within a defined large area and by which all tagged entities, i.e., individuals, equipment, materials, and vehicles that are provided with tags may be identified, electronically interrogated, communicated with either overtly or covertly, tracked, monitored, timed, and recorded. It can be linked with electromagnetic radiation detection, video, biometric, hand, finger, facial, eye, and other biological prints and chemical and other localized known gate type detection systems and sensors to increase and provide combined or coordinated overlapping detection and security systems. The active monitoring system is linked to the central processing component, which is capable of communicating to, receiving, analyzing, and recording the tag-related data or information received from the readers and from sensors. In a preferred embodiment of the active monitoring system component of the present invention, the readers and tags utilize radio frequency identification detection (“RFID”) methodology. More specifically, the invention utilizes preferably a plurality of RFID read/write transceivers as the readers and tags that are “smart” due to the use of RFID read/write chips. The smart tags are attached to aircraft, ground vehicles, personnel, and possibly items (“tagged entities”) that are to be monitored in the operations areas. In order to provide the desired safety and security, the readers may be placed in locations that may be harsh to delicate electronics. As a result, it is preferred that some or all of the elements of the active monitoring system component of the present invention used in such locations include a protective system component by which some or all of the active monitoring system component elements may be protected from the environment, and from rigorous loading conditions such as being driven over by an aircraft, or subjected to chemical abuse by de-icing fluid, for example. One preferred embodiment of the protective system component includes elements for the encapsulation and embedding of some or all of the elements of the active monitoring system component in a solid protective encapsulation. Other elements may require only weather resistant enclosures, depending on their location. One preferred embodiment of the protective system of the present invention permits unobtrusive surface or inpavement-mounted installation of elements such as the multiple RFID read/write transceivers and therefore the unhindered movement of personnel and vehicles. The protective system may also include protection for key components from electromagnetic pulse and other possible interference either by mechanical or electronic means. When a tag leaves a perimeter it can be de-activated on exit. Such tags may require re-authentication on return by time delay (off duty cycle), physical inspection, biometric inspection etc.

Embodiments of the active monitoring system component of the present invention may include directional lighting elements or include patterns, signs that make patterns or lines of light, or patterns, visible by design from a distance from one or more directions. The directionality of the light being emitted from the lighting elements can be adjusted by elements to emit in one direction. A similar directionality could be achieved by embedding the lighting guidance, or directional lighting elements system deeper into the pavement, so that the lighting elements would not be see, as the pavement would acted as a screen to cut off the light from being viewed from the horizontal, the undesirable direction. If desired, the light would only be seen from afar in the longitudinal direction, since in the longitudinal direction the ground would not screen or cut off the light. Thus by design, or by installation techniques, the lighting elements, the patterns, signs that make patterns, or lines of light, or patterns, can be made directional and only be seen from afar in one direction. Such embodiments, as with the rest of the active and passive management system may communicate to and be communicated from one or more central processors, and may be included as part of the management system, or as need be, can stand alone as an individual separate system.

Embodiments of the active monitoring system component of the present invention may include directional lighting elements to which the -readers are integrated such that individuals and vehicles may be provided with visual, active, or interactive communication, and/or guidance information with tagged aircraft, vehicles, people, items, while ground vehicles, personnel, and possibly items (e.g., tagged tool box, wrenches or other small items, power generator or any other type of equipment) may be identified and located and thereby managed in order, for example, to maintain security and prevent incursions. The system of the present invention provides sufficient flexibility so all personnel, vehicles, equipment, and materials within an operations area may be guided, tagged, identified, and tracked, and thereby managed. As such all inventory and personnel, i.e., tagged entities, at all times within the operations area, may be tracked, known, and managed.

The passive detection system component of the present invention monitors the same defined areas and paths for those animals, individuals, and vehicles not bearing a tag, i.e., non-tagged entities. Such a passive detection system may include strategically placed video,—sonics, and/or sensors such as forward looking infra red (“FLIR”) systems, radar, microwave, and other area and/or local proximity devices, metal detectors and other more limited devices by which specific stimuli—such as magnetic properties, pressure sensors, audio or some disturbance with some ground or air generated tagged electromagnetic signal—, may be detected and coordinated with the system so as to detect pre-identified anomalies and with the active system, thereby manage and secure operations areas and help prevent incursions and in the case of airports possible runway incursions. The passive monitoring system component would provide and communicate interactively information to one or more software driven central processors that in turn would be coordinated with a communication system so that appropriate action may be taken.

The central processing component of the present invention includes at least one central processor—that can accept, record process, time, and respond to information from some or all of the plurality of readers of the active monitoring system and information from the passive monitoring system. Preferably, the central processing component is able to coordinate the operation of the active and the passive monitoring system and act on detected anomalies, for example, to quickly provide notice that a certain pre-identified preprogrammed condition exists. One such pre-identified condition is that a vehicle or person is present in a certain monitored area that is not permitted to be in that area. The central processing component may provide such notice by comparing the information obtained from the active and the passive monitoring systems components. If both systems identify the presence of, for example, a person or vehicle within an operations area, and the person or vehicle bears a tag appropriate for the given area, the system may not warn those needing to know who or what is in the area. However, if both systems detect a person or vehicle in an operations area, and the person or vehicle does not bear a tag appropriate for the given area, or is completely missing a tag, those needing to know such information are notified. The central processing component, which may be programmed to send an alarm of the non-permitted intrusion, may send such notification. Advantageously, the central processing component may be configurable so that it can also quickly configure and reconfigure the readers and electronically reconfigure the tags to raise or lower the level of security of a particular ring of readers or sensors, or both so that at will, security codes can be changed, different zones of monitored areas can be created, and the security clearance assigned to particular tags can be changed. This is advantageous in that, if certain areas were raised to a higher security level, (perhaps around a particular high profile aircraft whose arrival is anticipated or, in times of crisis, around sensitive areas such as the fuel storage area of the airport), the areas may be monitored or more particularly monitored so that only certain vehicles, equipments, or individuals bearing only certain authorized tags would be permitted into those areas or along those paths. All other personnel and vehicles bearing improper tags or no tags would be detectable by the active and/or passive monitoring system component (described below) and may cause an alarm to be sounded, either at the site and or at the central processor or both, as needed, to notify the appropriate authorities. Identification and location of the intrusion would be known and tracked.

By the coordination of the active monitoring system component and the passive monitoring system component of the monitoring system of the present invention, management zones—such as, but not limited to those termed herein “surveillance rings” or “surveillance paths” —may be established to perform security functions as well as runway incursion, safety and time efficiency and inventory control, (depending on how complete the tagging was), and other management functions. Such management areas may be a separate management zone, area or areas nested within each other or closely associated with others. To illustrate, different areas of an airport typically have different security needs. For example, the personnel and vehicles permitted within areas of the airport tarmac in which baggage is handled and sorted, loaded and unloaded, and where perhaps aircraft are fueled, maintained, and parked are often very different. Such personnel and vehicles may be much different from those that are permitted access to other areas, such as out on the airfield where navigation equipment or power distribution enclosures are located. A single or a group of nested surveillance rings may be established to provide the different levels of security required for these different areas by the coordination of the active monitoring system component and the passive monitoring system component of the present invention. Any person or vehicle entering into those areas would be detected and identified when crossing the perimeter or perimeters by the active and passive component, and any movement along the perimeter would be tracked and timed as well by either or both of the active and passive systems component.

Specifically with respect to the “surveillance paths”, such paths may be definable by embodiments of the present invention in order to monitor the movement in more linear shaped areas or boundaries or borders such as along the centerline of taxiways and runways or along a pathway. Any vehicle or aircraft that deviated from a pre-identified route would be detected by the systems. All tagged entities, vehicles, aircraft, people, and even tagged items may be tracked and timed as they travel the prescribed surveillance paths. The readers, if encapsulated in the directional lighting elements may also provide a convenient means for mitigating runway incursions as all aircraft and vehicle locations and identifications would be known and tracked and could be guided by/to via specific paths to specific areas. Non-conforming vehicles, as in a newly arrived aircraft without an authorized tag, and therefore not known by the processor of the system, would be detected by the passive sensors linked to the system and the central processor may communicate this status so that appropriate action may be taken. An aircraft in such a situation may be more carefully chaperoned by air traffic control and other vehicles and people in the system may be notified in order to avoid such aircraft. The present invention may permit communications with sensors and recorders of the management system in order, for example, to track and record the non conforming aircraft and time and record its progress from sensor to sensor, or from light guidance to light guidance or both, to increase security, safety, as well as helping in time management efficiency studies and implementation of more management control and efficiency.

The central processing component of the system is preferably configurable so that tagged entities or targets—such as tagged vehicles, personnel, or items—may be monitored over “time” and their location identified. For example, baggage being transported between terminals on a transport vehicle may be monitored so that the path that the vehicle is taking can be identified and compared with an expected path, to determine whether the vehicle is deviating from that ideal path. Also, the amount of time that the vehicle is taking to make the trip can be determined by comparison of elapsed times between the frequent reader checkpoints placed in an area or along an expected path. Security, safety, and efficiency are thereby enhanced, since if a baggage transport vehicle strayed from its designated path it would be detectable. Similarly, if the vehicle for whatever reason took too long before being checked in by the next reader, it would be detected and an alarm could be activated for appropriate authorities to investigate. On a larger scale, if a task took too long to achieve (taking the baggage vehicle from one terminal to the next), it would also be detected and appropriate authorities notified. As such the management system of the present invention may be used to improve security, to facilitate actions taken because of an emergency, a runway incursion avoidance system, a guidance system, an efficiency time management system, and an inventory system.

Advantageously, the technology used to monitor the security areas, such as the surveillance rings and paths, may be complementary, and therefore be easily integrated into security systems already in place to monitor limited areas such as doorways and gateways to expand overall security. Similar integration can occur with vehicle guidance systems, and management control and efficiency or inventory tools, so that the area or airport as a whole is more secure, safer, and becomes more efficient.

Further advantageously, the technology may be manufactured at such a cost and have less energy requirements such that the system overall may be relatively less expensive, more reliable, and lightweight product used for a wide variety of applications and solutions. The technology for these applications is unobtrusive and often so seamless, that most users are unaware of its presence.

Advantageously, the system of readers and tags permits the monitoring of potentially irregular, concentric perimeter areas for the simultaneous identification of multiple RFID tags. Known systems only permit “access control” —that is, control of access through limited areas such as doorways and gates, while the present invention permits “freedom of movement” with full monitoring of simultaneous multiple RFID tag users.

Advantageously, the system of readers and tags permits the management of potentially all personnel, vehicles, items and other tagged entities within a large identified area, in order, for example, to increase security and safety for all those using the area in which it is installed and be easily integrated as a management tool to increase the efficiency of the airport, or any other area in which it is installed.

One embodiment of the area safety, security, and management efficiency system of the present invention is illustrated with reference to an airport, the present invention is sufficiently flexible such that it may be implemented in other contexts such as other exterior locations—such as military complexes and compounds, docks and interior locations such as within buildings, bunkers, warehouses or other interior natural or artificial building locations. Also contemplated by the present invention is the application or extension of the system into waterways, such as rivers, lakes, seaways, harbors, bays and the like.

Similarly in combination with sensors and readers, the security of a railroad system or port could be enhanced. A railroads rails, and bridges collectively known as “track” could be protected via a combination of a known security encoded tagged signal being propagated along the insulated track, with sensors positioned at intervals set to detect such signal. Shorts where these off track sensors detect the encoded security signal could mean a compromised track and would cause an alarm. Readers similarly positioned along said track could also monitor equipment and personnel RFID tags, anomalies being reported.

The reverse use of the tagged signal in combination with readers could protect ports where known tagged security encoded signals could be continuously generated across harbors and within the water of the harbors, via and between sensors, creating an electronic tagged signal barrier, within the water and across the harbors; disturbances, other than known vessels, would/could cause an alarm, unless pre-positioned readers and the directing computer(s), simultaneously received conformation that the disturbances were caused by known (RFID tagged) equipment and personnel, who were authorized to be in the detected area at that time.

A similar local active system could also be incorporated within a vehicle such as an aircraft, with key aircraft or vehicle components tagged. One or more reader/writer sections and the smart chips could be used for different key parts of a vehicle to allow the vehicle have its own management control, security, maintenance timing and perhaps inventory control system. Here, different tagged items of key equipment could be monitored as to their timed usage and key maintenance times. In case of an accident different parts of the vehicle could have smart chips that survived an accident and be separated and left the whole, at different times, yet all chips would have the same vehicle security code on the chips identifying where it came from, with surviving information up to the time they were separated from the vehicle. Here such a system might help investigators tell how an accident occurred, as the separated sections or segments of the vehicle might have different time codes or some other information deliberately implanted in them at the time of catastrophe. For example with respect to any airplane crash, treated fire resistant, or intrinsically fire proof chips, strategically placed on all key airplane parts, may be discoverable and analyzed such that investigators of the crash may be able to tell which part came off first, as the time sequence within the chips would be available to be read by portable readers. This would help determine how and why the airplane broke up. In other words as a supplement to the black boxes, perhaps some or all of the flight data, time etc. could be continuously updated and instantaneously distributed around the vehicle at all times, so that in the event of some part separating from the vehicle, the smart chip or chips would have some or all of the relevant data encoded into them to help investigators reconstruct what had happened.

Such a system would also help in the overall security of an airport, military base or other large area equipped with the active and passive system. An equipped vehicle entering such and area could automatically check in and have its parts, with tagged smart chips, report in and be updated as to the local security protocol. The system would also help safety, since key parts could identify when they were made, how long they have been in service, when was their last service or similar management control data, without specifying such data, but would make vehicle maintenance much easier to track and schedule and control. Although the discussion has been illustrated by talking about aircraft, it is understood any type of vehicle could be similarly equipped.

The active monitoring system component of the illustrated embodiment may include one or more of a plurality of readers—such as RFID interrogators (read/write transceivers)—and sensors—such as biometric sensors, sensors for pattern recognition, hand, voice, eye, finger, facial “prints”, or chemical, positional, electromagnetic detection, pressure sensors, audio or some disturbance with some ground or air generated tagged electromagnetic signal or other sensor/detector systems, or coordinated with other systems for “access control” —that is, control of access through limited areas such as doorways and gates that lead from a perimeter to an operations area. Beyond such access areas, management of an operations area is further achieved through the use of sensors, or read/write transceivers, situated within a suitable range of each other and in a given pattern to define, for example, a surveillance ring or path. One such pattern may be defined by the positioning of a reader approximately every 1 to 15 feet. Some readers and tags may allow the spacing to exceed 1000 ft. The spacing will, however, vary according to the actual reader or sensor used and its range. Concentric or nested zones may be established to provide more refined proximities for security monitoring. Each reader or sensor is provided with its own identifying designation so the general location of the occupant may be determined. For enclosed areas, such as for surveillance rings, the readers preferably radiate their signals inward in order to minimize false alarm transgressions into higher-level restricted areas. Readers for surveillance paths (taxiways, runways, airport roads) may preferably radiate omni-directionally. Identifying information to and from the tags is sent from the readers via integral and interconnected sensor wires or radio data link to the host processor. For areas difficult to monitor, microwave motion sensors and/or other detectors could be used because of their low power and could be powered by the same wiring used for surveillance rings or paths. To achieve large area coverage, other detector systems might require more power and/or other type detectors, such as video surveillance, radar, microwave, sonics, ultraviolet or forward looking infrared (“FLAR”) type technologies could cover large areas. Such devices are known, but the unique application of coupling them to zones of security for the large area control or coupling them to a vehicle with all key components tagged is new. The processor component would correlate movement in a particular zone to the RFID tags. Uncorrelated or improperly tagged or untagged movement would constitute an intrusion and sound an alarm.

The illustrated system includes micro-mechanical read/write RFID tags incorporated, for example, into personnel badges, and attached to vehicles, items (e.g., baggage), and to the wheel struts of aircraft. Since these tags derive no power from the aircraft and have a mass equivalent to a lightweight flexible card key, it is expected that the affixation of them to aircraft should not require a type certification. Other transponder type tags may be self-powered via battery, solar or other means. Their low power requirement and reflection, low cost, ruggedness, and high reliability makes them ideal for use on items, people, vehicles, and aircraft.

The processing component may automatically communicate with or receive information from, track, time monitor, and record the movement history of all tags in the system. A systems operator may locate and write information to a specific tag or set of tags as needed, to change tag security coding, or find information for management control, using the nearest RFID interrogator quickly and at will. The system of this invention is intended to interface seamlessly via the airport's LAN/WAN for tag data sharing and correlation of readings from in-airport and airline tag readers.

The system may utilize some or all of the following type motion detector and RFID components, or any other similar type RFID components with similar generic function:
MS Sedco Microwave Sensor—TC-26B
SCS Corporation Dura-label—DL-1000, DL-9000, and Readers
Amtech AEI Tags and Reader—AT5110, AT5125, and WV3100
Texas Instruments RFID—125 KHz Tags and Readers

Preferably, the sensors and RFID readers include a protective system to protect each from damage such as from moisture, rain, or snow or that caused by the weight of individuals, materials, or vehicles that travel over or are placed on the interrogators. Such protective systems can include the encapsulation of the interrogators, tags and other electronic components of the active monitoring system in thermoplastic molding, extrusion, or casting, or other materials, depending on location, size, type, and costs. For example, the molding may be flush-mounted into the pavement about 1.75 to 3 or more inches, depending on the detector system, to enclose all wiring. The RFID interrogators may require a broader profile, about 2 by 5 inches or perhaps more, and 2 or more inches deep and be injection molded or cast. A magnetic sensor may be extruded and only 0.5 inch deep. The injection molding, extrusion or casting material is designed to provide weather protection and other protection, such as to relieve stress to wiring and connections due to extreme dynamic impact, typical of heavy jets. Other tags may be intrinsically resistant to the environment they are designed to work in and need no covering, or encapsulation and/or may be installed within a resistant box; such is dependant on the needed circumstances and the locations they are designed to work in.

In another embodiment, the components of the system or systems could be portable, modular and self powered via solar and or replaceable/rechargeable battery, suitable for repeated battlefield deployment, to duplicate a static area deployment and create active RFID security zones, again interacting with a field deployable passive sensor system, enabling complete local area control or remote asset awareness for both the tagged friendlies and the untagged hostiles. The discrete modules may be activated either manually or via transponder, so allowing for instant, remote on/off capability, in case of enemy proximity. The response to the digital signal may be selectable via embedded security chip, as part of the transponder circuitry. The system may be made capable of being included into and becoming part of the BOWMAN or other digital battlefield communication systems. The modules may be self powered and come with either replaceable or embedded rechargeable batteries.

The objectives, advantages and features of the invention will be further appreciated upon consideration of the following detailed description of an embodiment taken in conjunction with the drawings.

### BRIEF DESCRIPTION OF THE DRAWINGS

FIG. 1 is an illustration of one embodiment an encapsulated read/write device for identifying tags according to the present invention;

FIG. 2 is an illustration of an airport terminal with a plurality of management zones defined by components of an active monitoring system and a passive monitoring system according to one embodiment of the invention;

FIG. 3 is an illustration of components arrayed to define different patterns of management zones;

FIG. 4 is an illustration of a directional management zone according to one embodiment of the invention; and

FIG. 5 is an illustration depicting a system for management of a management zone according to one embodiment of the invention.

### DETAILED DESCRIPTION OF EMBODIMENTS OF THE INVENTION

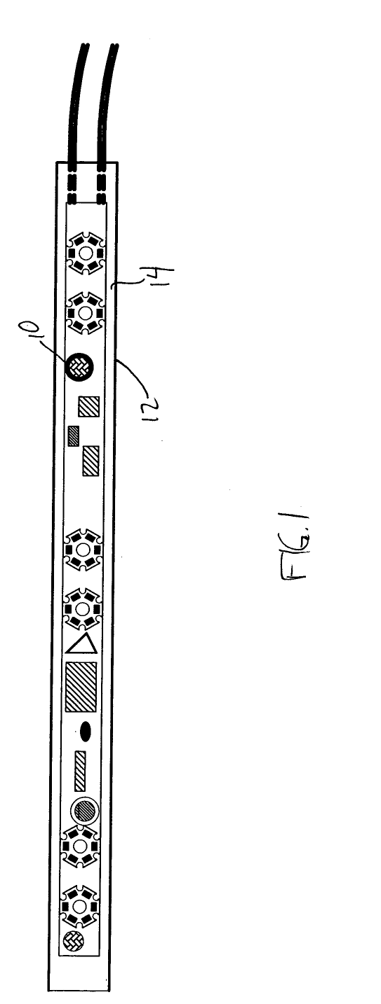

FIG. 1 illustrates one embodiment of an enclosure 12 including a read/write device 10 for use in the facilities management system according to this invention. The read/write device 10 is thus well adapted for use in stressful environments, such as roadways, waterways, landing strips, high traffic walkways, warehouses, and the like. When so deployed, the device 10 is preferably encapsulated and/or potted in the enclosure 12, enclosed or contained therein. The enclosure 12 may be a plastic housing or formed of another suitable material, with or without a gasket to provide a seal 14 to the enclosure or an extruded, cast, molded enclosure or the like.

The read/write device 10 functions as a tag sensor, which is an electronic device for sensing, reading, identifying and, optionally writing to a tag, such as a RFID tag (not shown). Other such electronic devices, which may be arranged on the enclosure 12, include transmitters, antennae, LEDs, and various other sensors as described above (not shown).

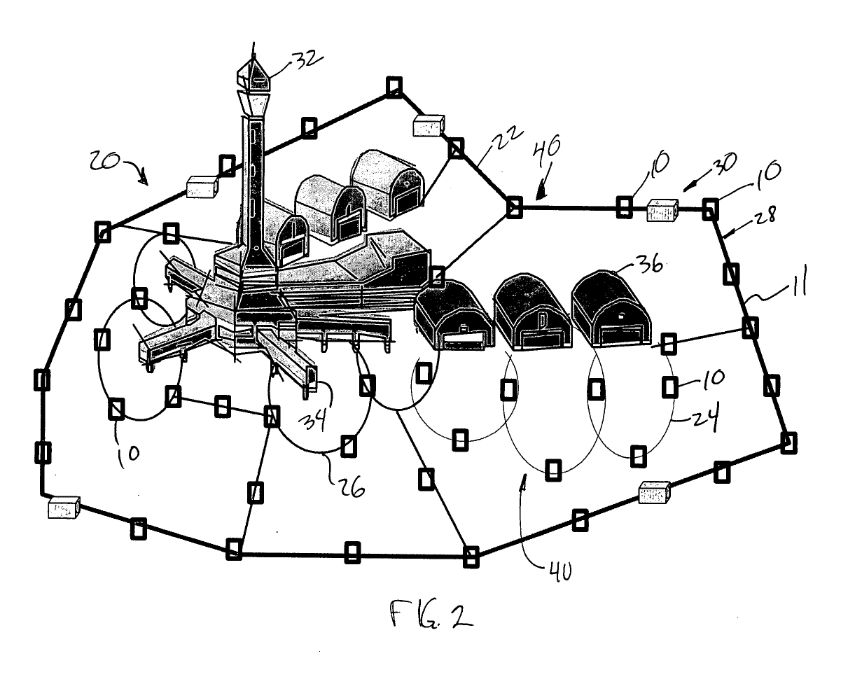

FIG. 2 illustrates an airport terminal 20 with a plurality of management zones 22, 24, 26 defined with a operations area 11 organized into nested surveillance rings, which are defined by components of an active monitoring system 28 and a passive monitoring system 30 according to one embodiment of the invention. Typically, an airport terminal includes a control tower 32, for controlling air traffic and the like associated with the airport. The terminal 20 typically includes one or more gates 34 and hangers 36 and the like. It will be understood that there is a desire to monitor movement and activity of people, vehicles and materials within and through these areas. Accordingly, readers 10 are disposed, arranged or arrayed in such a fashion so as to define zones of security or management zones 40. It will be understood that the management zones 40 are set forth to most effectively monitor the ingress and egress of people, materials, vehicles and the like, in any suitable pattern of organization. Furthermore, the readers 10 may be arranged so as to form boundaries or borders in closed or linear arrays, in that as a tagged entity approaches the outer range of one or more of the readers, the entity will be detected and so on. The range of the readers 10 thus, forms a boundary having a predetermined scope. For example, the illustrated terminal 20 includes a first management zone 22 disposed around the entire periphery of the terminal 20. A second management zone 24 is nested within the first management zone 22 so as to provide an internal subset of the first zone 22 and monitor activity to and from a first hanger 36. A third management zone 26 is disposed within the first management zone 22 so as to provide an internal subset of the first zone and monitor activity to and from a first concourse or gate 34.

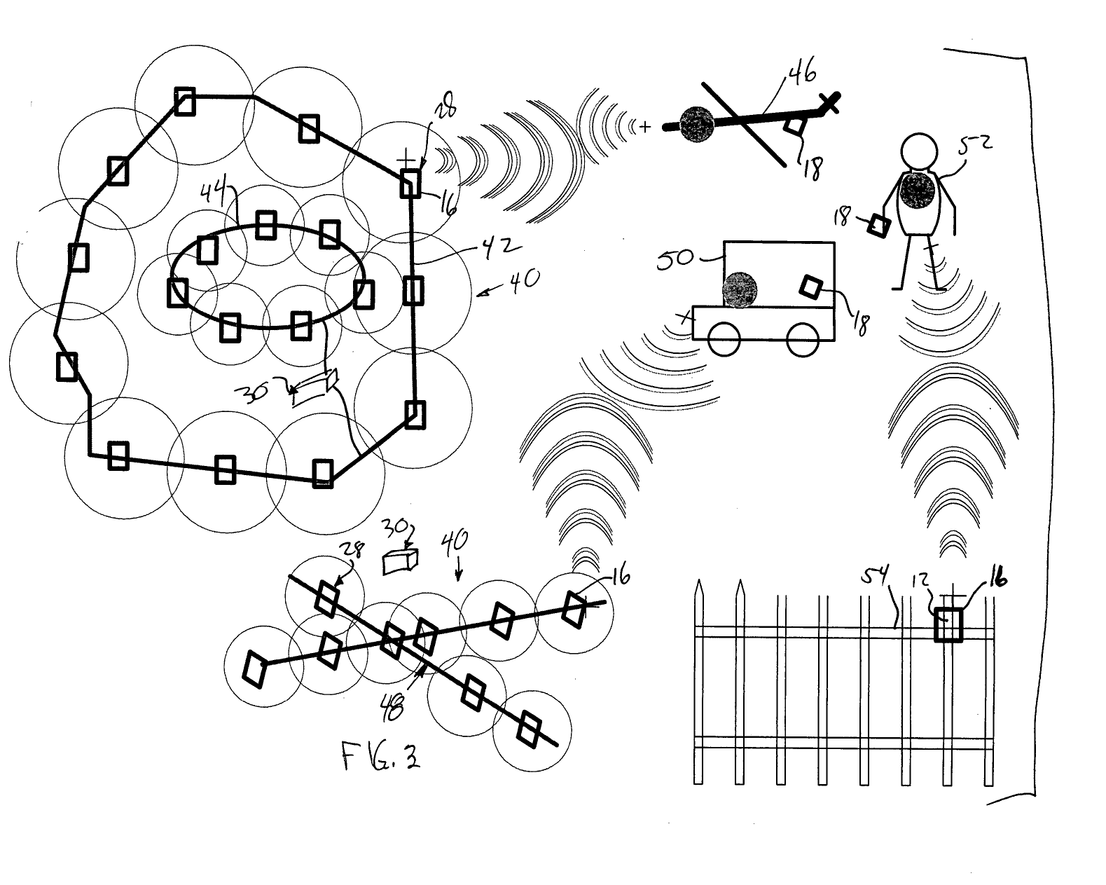

FIG. 3 illustrates arrays of components used to define two embodiments of management zones 40 according to the present invention. The readers 10 (see FIG. 1) including components of the active system 28 and optionally the passive system 30 may be arranged in concentric circles 42, 44. An outer perimeter 42 includes components arranged so as to provide overlapping ranges of detection 46. An inner perimeter 44 is disposed within the outer perimeter 42 of the management zone 40 so as to provide a second subset of monitoring internal to the outer perimeter. An airplane 46 is being shown in communication, i.e. detected, by a tag sensor 16 in the outer perimeter 42 of the management zone 40. The tag sensor 16 may also be writing to a tag 18 on the airplane 46.

A second embodiment of a management zone 40 is shown arrayed into a linear form or intersecting linear form at surveillance path 48. In this embodiment, the components of the active monitoring system 28 and passive monitoring system 30 are arrayed into essentially linear form so as to provide a mechanism to detect and monitor tagged and non-tagged entities. The linear surveillance path 48 may be best disposed across and/or along pathways, roadways, fences or other essentially linear travel ways. In do doing the linear surveillance path or boundary may function as a hidden gate or portal.

A vehicle 50 is being shown in communication, i.e. detected, by a tag sensor 16 in the linear surveillance path 48 of the management zone 40. The tag sensor 16 may also be writing to a tag 18 on the vehicle 50. The tag sensors 16 may be mounted in or on a suitable enclosure 12 on a fence 54, for example, which may be an efficient mechanism to detect and monitor persons 52.

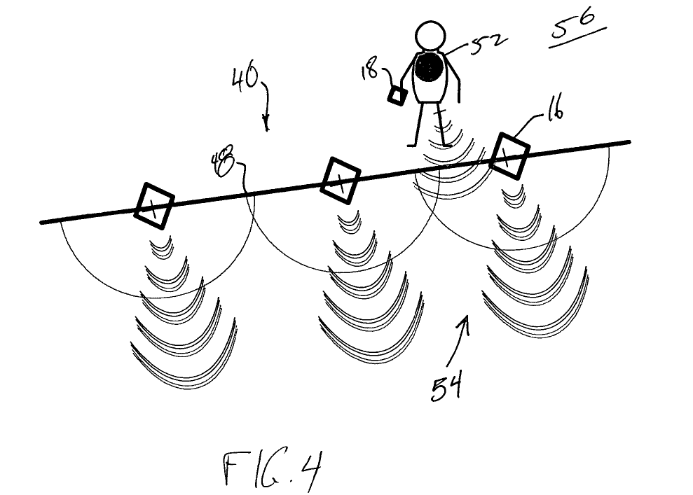

FIG. 4 illustrates a management zone 40 according to an embodiment of the present invention. The management zone 40 is defined by a linear surveillance path or array 48 of tag sensors 16. The sensors 16 are directional sensors, which are only capable of receiving signals from tag 18 on person 52 which arrive from a specified direction 54. Signals originating from a second side 56 are suppressed. In this manner, the management zone 40 only extends a specified direction 54.

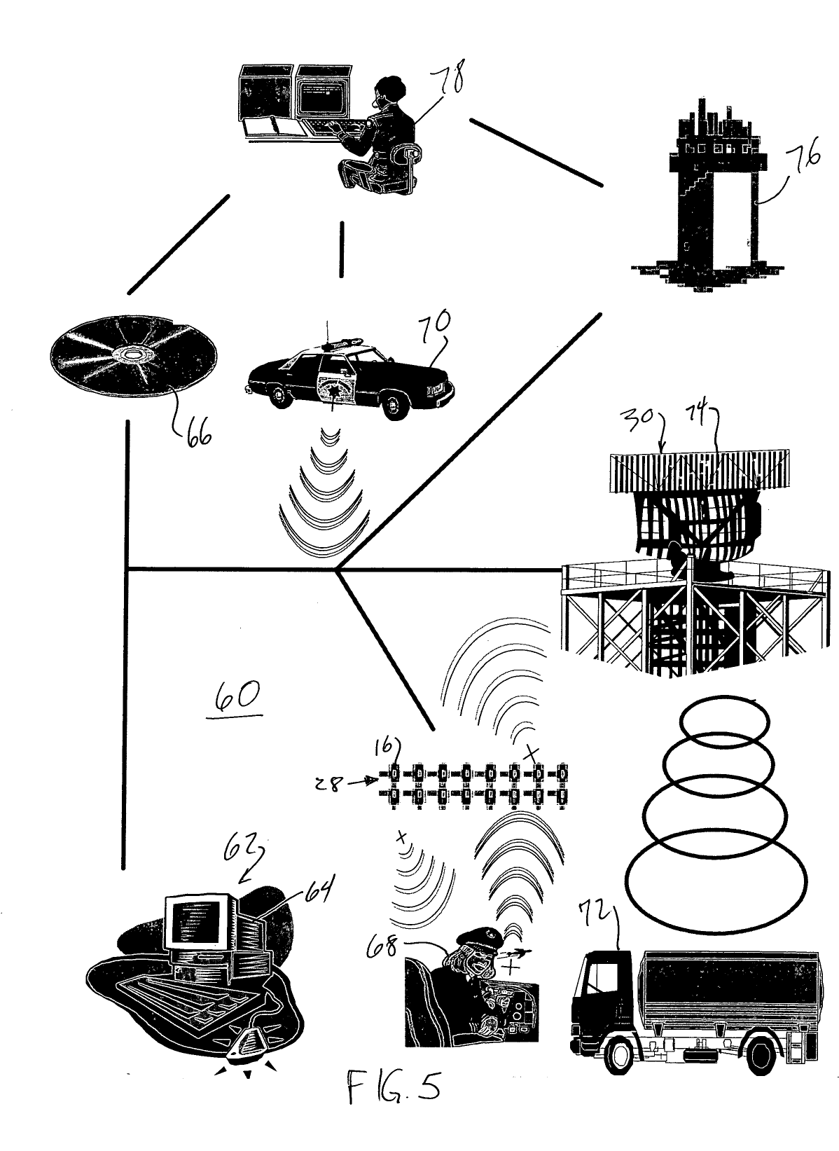

FIG. 5 illustrates a system 60 for management of a management zone according to one embodiment of the invention. The system 60 includes a central processing component 62 including one or more central processors 64. The central processing component 62 includes and operates by way of a software operating system including database and asset-tracking software 66. The system 60 includes components 16 of an active monitoring system 28, which are operatively connected to the central processing component 62. Examples of tagged entities include pilot 68 and security vehicle 70, which are monitored by the active monitoring system 28. An example of a non-tagged entity is vehicle 72, which is detected and monitored by a passive monitoring component 30, for example, a radar station 74, also connected to the central processing component 62. Control tower 76 is in communication with the system 60 and a ground security operator 78. The control tower 76 may report to the security system 60 and the security operator 78. The control tower may also receive information from the system 60.

In response to a triggered alarm, the system 60 can initiate automatic response (such as lock down gates, de-activate vehicles, trigger fire alarm systems and switch on sprinklers) or permit a manual response (system alarms operator who decides what response is needed).

Thus, while the invention has been described with respect to certain preferred embodiments, it will be understood by those of skill in the art that there are modifications, substitutions and other changes that can be made, yet will still fall within the intended scope of the invention, as set forth in the following claims.

1. A system for management of an operations area, said management system comprising:
a monitoring system including an active monitoring system component including tags and readers for individual identification of one or more tagged entities, said active monitoring system component arrayed to create said operations area and a passive monitoring system component by which non-tagged entities entering said operations area may be identified and additional information communicated to said central processing component for analysis; and
a central processing component including one or more central processors being in operative communication with said active monitoring system component said passive monitoring system component such that information from said active monitoring system component and said passive monitoring system component may be received and analyzed by said central processing component.

2. The system of claim 1 wherein said operations area includes a plurality of surveillance rings.

3. The system of claim 1 wherein said operations area includes a plurality of nested surveillance rings.

4. The system of claim 1 wherein said operations area includes a surveillance path.

5. The system of claim 1 wherein said operations area includes a plurality of surveillance paths.

6. The system of claim 1 wherein said readers include read/write capability.

7. The system of claim 1 wherein said tagged entities include one or more of personnel, vehicles, equipment and documents.

8. The system of claim 1 wherein said non-tagged entities include one or more of personnel, vehicles, equipment and documents.

9. The system of claim 1 wherein said readers are encapsulated.

10. The system of claim 1 wherein said tags are RFID tags.

11. The system of claim 1 wherein said tags include RFID tags and readers.

12. The system of claim 1 wherein said tags are encapsulated into a weather resistant enclosure.

13. The system of claim 12 wherein said enclosure is sufficiently robust enough to be placed into a road and survive being contacted by vehicles.

14. The system of claim 12 wherein said tags are encapsulated by one of injection molding, extrusion or casting

15. The system of claim 1 wherein said readers are capable of detecting and reporting on one or more of radiological, chemical, biological, proximity, weight, light, electronic, magnetic, and sound properties and tagged signal, video, infra red, and ultra violet video.

16. The system of claim 15 wherein said readers function as an emitter.

17. The system of claim 1 wherein said readers communicate with said passive monitoring system component and function to identify one or more of non-tagged entities.

18. The system of claim 1 wherein said readers function to detect one or more of radiological, chemical, biological, proximity, weight, light, electronic emissions, magnetic, low sound frequency, medium sound frequency, ultrasonic sound frequency, tagged signal, video, infrared, and ultra violet video properties.

19. The system of claim 1 wherein said computer component performs a comparison between said tags and said readers to detect one or more of people, vehicles, animals, items, radiological, chemical, biological, proximity, weight, light, electronic, magnetic, sound, tagged signal, video, infra red or ultra violet video.

20. The system of claim 1 wherein said passive monitoring system includes an electromagnetic emitter which is emitted to form a barrier, said barrier, when broken causes an alert.

21. The system of claim 1 wherein said active monitoring system component and said passive monitoring system component is arranged so as to present hidden gates to define a highly secure management zone within said operations area.

22. The system of claim 21 wherein said highly secure management zone can only be entered from a predetermined direction by authorized personnel.

23. The system of claim 1 wherein said system includes a mechanism to track time of a tagged entity traveling from a first reader to a second reader.

24. The system of claim 1 wherein said tags include a mechanism to identify other tags and report and store information related to the other tags.

25. The system of claim 1 wherein said central processing component includes a mechanism to determine the position of a sensed tag.

26. The system of claim 1 wherein said system is connected through one or more of an Internet or an intranet, by wireless, LAN/WAN, cable, satellite, power line, global positioning system, microwave, low frequency or ultra sonics.

27. The system of claim 1 wherein two or more said systems are interlinked through one or more of an Internet or an intranet, by wireless, LAN/WAN, cable, satellite, power line, global positioning system.

28. The system of claim 1 wherein said readers may be sequenced and act as a switch to turn on a different reader.

29. The system of claim 1 wherein said readers include a RFID antenna that is omni-directional.

30. The system of claim 1 wherein said readers include a RFID antenna that suppresses signals from at least one direction.

31. The system of claim 1 including a plurality of tags deployed onto key components of a vehicle.

32. The system of claim 31 wherein each of said plurality of tags is continuously updated as to the status of the key component.

33. The system of claim 1 wherein communication within said system is encoded.

34. The system of claim 1 wherein said operations area defines one or more boundary.

35. A method of operating a system for management of an operations area comprising:
deploying a monitoring system including an active monitoring system component for individual identification of one or more tagged entities and a passive monitoring system component for identification of one or more non-tagged entities;
providing the tagged entities with tags;
arraying the active monitoring system component to define an operations area;
arraying the passive monitoring system component to monitor the operations area in coordination with the active monitoring area; and
monitoring information from the monitoring system.

36. The method of claim 35 further comprising:
providing a central processing component for said monitoring of the information.

37. The method of claim 35 further comprising:
tracking non-tagged entities with the passive monitoring system component.

38. The method of claim 36 wherein information from the active monitoring system is compared to information from the passive monitoring system by the central processing component and an alarm is triggered when a predetermined condition results from said comparison.
